(19) United States
(12) Patent Application Publication
(10) Pub. No.: US 2026/0022734 A1
(43) Pub. Date: Jan. 22, 2026

(54) FOIL BEARING

(71) Applicant: KABUSHIKI KAISHA TOYOTA JIDOSHOKKI, Kariya-shi (JP)

(72) Inventors: Noriyuki SHINTOKU, Kariya-shi (JP); Hironao Yokoi, Kariya-shi (JP); Satoru Egawa, Kariya-shi (JP); Fumiya Shinoda, Kariya-shi (JP); Masahiro Suzuki, Kariya-shi (JP)

(73) Assignee: KABUSHIKI KAISHA TOYOTA JIDOSHOKKI, Kariya-shi (JP)

(21) Appl. No.: 19/257,667

(22) Filed: Jul. 2, 2025

(30) Foreign Application Priority Data
Jul. 17, 2024 (JP) 2024-114001

(51) Int. Cl. F16C 17/02

(52) U.S. Cl. CPC F16C 17/024

(57) ABSTRACT

A foil bearing includes a bearing housing having a through hole through which a rotation shaft is inserted, a thin-plate-shaped top foil, and a thin-plated-shaped bump foil. The top foil includes a tubular top foil body and trailing and leading edge tabs. The trailing and leading edge tabs are inserted in a slot of the bearing housing. The slot is defined by a slot wall including a leading wall located at a leading side in a rotational direction of the rotation shaft. The trailing edge tab extends in the slot at a radial outer side of the leading edge tab and includes a distal portion configured to contact the leading wall at least when the rotation shaft is rotating. The leading edge tab is separated from the leading wall and the trailing edge tab in a circumferential direction of the rotation shaft at least when the rotation shaft is rotating.

### CROSS-REFERENCE TO RELATED APPLICATIONS

This application is based upon and claims the benefit of priority from Japanese Patent Application No. 2024-114001, filed on Jul. 17, 2024, the entire contents of which are incorporated herein by reference.

### BACKGROUND

### 1. Field

The present disclosure relates to a foil bearing that supports a rotation shaft in a radial direction.

### 2. Description of Related Art

The foil bearing supporting the rotation shaft in the radial direction includes a bearing housing, a top foil, and a bump foil. The bearing housing has a through hole through which the rotation shaft is inserted. The top foil has the form of a thin plate. The top foil is disposed between the rotation shaft and the bearing housing. The bump foil has the form of a thin plate. The bump foil is disposed between the bearing housing and the top foil. The bump foil elastically supports the top foil.

Such a foil bearing supports the rotation shaft so that the rotation shaft is in contact with the top foil until the rotation speed of the rotation shaft reaches a lift-off speed. When the rotation speed of the rotation shaft reaches the lift-off speed, the dynamic pressure of a film of fluid generated between the top foil and the rotation shaft causes the rotation shaft to lift off from the top foil. Thus, the foil bearing supports the rotation shaft without contacting the rotation shaft.

Japanese Patent No. 5449553 describes an example of a bearing housing including a slot formed in the inner circumferential surface of the bearing housing. The slot extends in the axial direction of the bearing housing. The top foil includes a top foil body, a trailing edge tab, and a leading edge tab. The top foil body is tubular. The top foil body includes a bearing surface supporting the rotation shaft and surrounds the outer circumferential surface of the rotation shaft. The trailing edge tab is formed of an end of the top foil body located at the trailing side in the rotational direction of the rotation shaft being bent outward in the radial direction of the rotation shaft. The leading edge tab is formed of an end of the top foil body located at the leading side in the rotational direction of the rotation shaft being bent outward in the radial direction of the rotation shaft. The trailing edge tab and the leading edge tab are inserted in the slot.

In such a foil bearing, when the rotation shaft rotates, a trailing portion of the top foil body located at the trailing side in the rotational direction, where the trailing edge tab is located, may be drawn toward the rotation shaft by the flow of the fluid flowing between the top foil and the rotation shaft. When the trailing portion of the top foil body in the rotational direction is drawn toward the rotation shaft, the trailing portion of the top foil body may be caught on the rotation shaft. The catching of the trailing portion of the top foil body on the rotation shaft hinders the rotation shaft from being lifted off by the dynamic pressure of the fluid film generated between the top foil and the rotation shaft. As a result, the rotation shaft may not be stably supported.

When movement of the leading edge tab is hindered and the dynamic pressure of the fluid film is generated between the top foil and the rotation shaft, a leading portion of the top foil body located at the leading side in the rotational direction, where the leading edge tab is located, is hindered from deforming so as to bend in a direction separating away from the rotation shaft. As a result, the gap between the leading portion of the top foil body in the rotational direction and the rotation shaft is not readily increased, and the fluid is not readily drawn in from the gap between the leading portion of the top foil body and the rotation shaft. This hinders the rotation shaft from being lifted off by the dynamic pressure of the fluid film generated between the top foil and the rotation shaft. As a result, the rotation shaft may not be stably supported.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure is a foil bearing that supports a rotation shaft in a radial direction. The foil bearing includes a bearing housing having a through hole through which the rotation shaft is inserted, a top foil disposed between the rotation shaft and the bearing housing and having a form of a thin plate, a bump foil disposed between the bearing housing and the top foil and elastically supporting the top foil. The bump foil has a form of a thin plate. A slot is formed in an inner circumferential surface of the bearing housing and extends in an axial direction of the bearing housing. The top foil includes a tubular top foil body including a bearing surface that supports the rotation shaft and surrounding an outer circumferential surface of the rotation shaft, a trailing edge tab formed of an end of the top foil body located at a trailing side in a rotational direction of the rotation shaft being bent outward in a radial direction of the rotation shaft, and a leading edge tab formed of an end of the top foil body located at a leading side in the rotational direction being bent outward in the radial direction. The trailing edge tab and the leading edge tab are inserted into the slot. The slot is defined by a slot wall including a leading wall located at the leading side in the rotational direction. The trailing edge tab extends in the slot at an outer side of the leading edge tab in the radial direction. The trailing edge tab includes a distal portion configured to contact the leading wall at least when the rotation shaft is rotating. The leading edge tab is separated from the leading wall and the trailing edge tab in a circumferential direction of the rotation shaft at least when the rotation shaft is rotating.

Other features and aspects will be apparent from the following detailed description, the drawings, and the claims.

### BRIEF DESCRIPTION OF THE DRAWINGS

FIG. 1 is a schematic diagram showing a centrifugal compressor including an embodiment of a radial bearing.

FIG. 2 is an enlarged partial cross-sectional view of the centrifugal compressor shown in FIG. 1.

FIG. 3 is a cross-sectional view illustrating the radial bearing shown in FIG. 1.

FIG. 4 is an exploded perspective view illustrating the radial bearing shown in FIG. 1.

FIG. 5 is an enlarged partial cross-sectional view of the radial bearing shown in FIG. 1.

FIG. 6 is a cross-sectional view of a rotation shaft supported by the radial bearing shown in FIG. 1 and moved in a radial direction.

FIG. 7 is a cross-sectional view of a rotation shaft supported by the radial bearing shown in FIG. 1 and moved in a radial direction.

FIG. 8 is an enlarged partial cross-sectional view of the radial bearing shown in FIG. 1.

FIG. 9 is an enlarged partial cross-sectional view of a modified example of a radial bearing.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment of a foil bearing will now be described with reference to FIGS. 1 to 8. The foil bearing of the present embodiment is applied to a centrifugal compressor mounted on a fuel cell electric vehicle. The fuel cell electric vehicle includes a fuel cell system that supplies oxygen and hydrogen to a fuel cell to generate power. The centrifugal compressor compresses air, that is, fluid including oxygen, supplied to the fuel cell.

### Overview of Centrifugal Compressor

As shown in FIG. 1, a centrifugal compressor 10 includes a housing 11, a rotation shaft 12, an impeller 13, and a motor 14. The motor 14 rotates the rotation shaft 12. The housing 11 is tubular. The housing 11 accommodates the rotation shaft 12, the impeller 13, and the motor 14. The rotation shaft 12 is rotated as the motor 14 is driven. The impeller 13 is coupled to a first end of the rotation shaft 12. The impeller 13 rotates integrally with the rotation shaft 12 to compress air.

The centrifugal compressor 10 includes two radial bearings 15. The radial bearings 15 are arranged in the housing 11. The radial bearings 15 are located at opposite sides of the motor 14. The radial bearings 15 support portions of the rotation shaft 12 located at the opposite sides of the motor 14. Each radial bearing 15 is a foil bearing that rotatably supports the rotation shaft 12 in the radial direction. The “radial direction” refers to a direction orthogonal to the axial direction of the rotation shaft 12. Thus, the “radial direction” is the radial direction of the rotation shaft 12.

The housing 11 includes a compressor housing member 16 and a housing plate 17. The compressor housing member 16 is tubular and has an inlet 18. Air is cleaned by an air cleaner (not shown) and then flows to the inlet 18. The housing plate 17 is joined to the compressor housing member 16. The housing plate 17 and the compressor housing member 16 together define an impeller chamber 19. The impeller chamber 19 is connected to the inlet 18. The impeller chamber 19 accommodates the impeller 13. The first end of the rotation shaft 12 projects through the housing plate 17 into the impeller chamber 19.

The housing 11 includes a diffuser passage 20 and a discharge chamber 21. The diffuser passage 20 and the discharge chamber 21 are defined by the compressor housing member 16 and the housing plate 17. The diffuser passage 20 is arranged at an outer side of the impeller chamber 19 in the radial direction of the rotation shaft 12. The diffuser passage 20 annularly extends around the impeller chamber 19. The discharge chamber 21 is disposed at an outer side of the diffuser passage 20 in the radial direction of the rotation shaft 12. The discharge chamber 21 annularly extends around the impeller chamber 19. The diffuser passage 20 connects the impeller chamber 19 and the discharge chamber 21.

When air is drawn from the inlet 18 into the impeller chamber 19, the air flows toward the diffuser passage 20 as the impeller 13 rotates. As the air flows through the diffuser passage 20, the air is increased in pressure and discharged to the discharge chamber 21. The air discharged to the discharge chamber 21 is supplied to the fuel cell. Thus, the impeller 13 rotates together with the rotation shaft 12 to compress air that is supplied to the fuel cell. In the description below, the rotational direction of the rotation shaft 12 when the impeller 13 compresses the air may be referred to as a “rotational direction R1.” As described above, the rotation shaft 12 is configured to rotate in a single rotational direction.

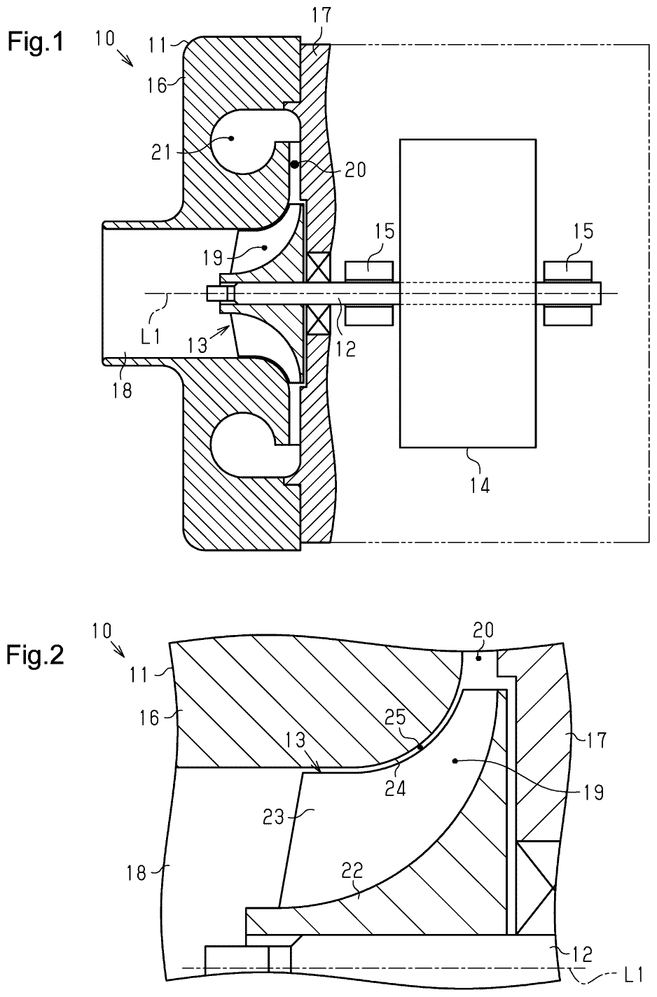

As shown in FIG. 2, the impeller 13 includes a hub 22 and vanes 23. The hub 22 rotates integrally with the rotation shaft 12. The hub 22 is coupled to the first end of the rotation shaft 12. The hub 22 includes a front end located adjacent to the inlet 18 and a rear end located at a side opposite to the front end. The hub 22 is cone-shaped and has an outer diameter gradually increasing from the front end toward the rear end. The hub 22 includes a curved surface that is concaved toward an axis L1 of the rotation shaft 12.

The vanes 23 are arranged in the circumferential direction of the hub 22. The vanes 23 are arranged on the surface of the hub 22 at equal intervals in the circumferential direction. Since the outer diameter of the hub 22 increases from the front end toward the rear end, the distance between the vanes 23 located adjacent to each other in the circumferential direction of the hub 22 gradually increases from the front end toward the rear end of the hub 22.

The compressor housing member 16 includes a shroud 24. The shroud 24 defines the impeller chamber 19. The shroud 24 is opposed to the hub 22 and extends along the surface of the hub 22. The shroud 24 surrounds the vanes 23. The vanes 23 are spaced apart from the shroud 24 by a tip clearance 25. As described above, the tip clearance 25 is provided between the impeller 13 and the shroud 24. The tip clearance amount between the impeller 13 and the shroud 24 is set so that the vanes 23 do not contact the shroud 24 even when the impeller 13 moves in the impeller chamber 19 in accordance with movement of the rotation shaft 12 in the radial direction of the rotation shaft 12. The tip clearance amount is calculated in advance based on tests or the like.

### Radial Bearing

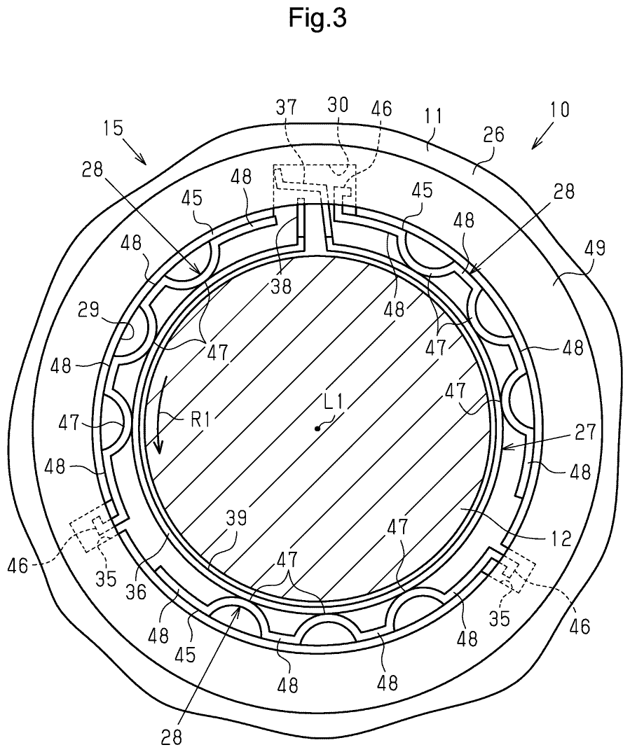

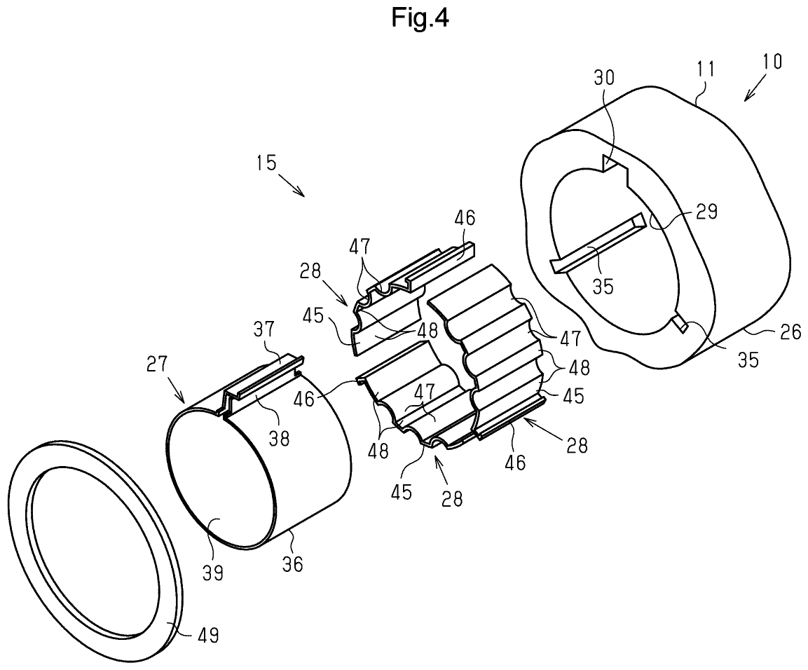

As shown in FIGS. 3 and 4, each radial bearing 15 includes a bearing retainer 26, a top foil 27, and a bump foil 28. The bearing retainer 26 is tubular. The bearing retainer 26 is part of the housing 11. The bearing retainer 26 includes a first end surface and second end surface located at opposite sides in the axial direction. The bearing retainer 26 has a through hole 29 through which the rotation shaft 12 is inserted. The through hole 29 has openings in the first end surface and the second end surface of the bearing retainer 26. Thus, the bearing retainer 26 serves as a bearing housing having the through hole 29 through which the rotation shaft 12 is inserted.

As shown in FIG. 3, the top foil 27 is opposed to the rotation shaft 12 in the radial direction. The top foil 27 is disposed between the rotation shaft 12 and the bearing retainer 26. The bump foils 28 and the rotation shaft 12 are disposed at opposite sides of the top foil 27. The bump foils 28 are disposed between the bearing retainer 26 and the top foil 27. The bump foils 28 elastically support the top foil 27.

### Slot

A slot 30 is formed in the inner circumferential surface of the bearing retainer 26, that is, the wall surface of the through hole 29. The slot 30 extends in an axial direction of the bearing retainer 26. The slot 30 has a first end opening in the first end surface of the bearing retainer 26. The slot 30 includes a second end closed by a portion of the bearing retainer 26.

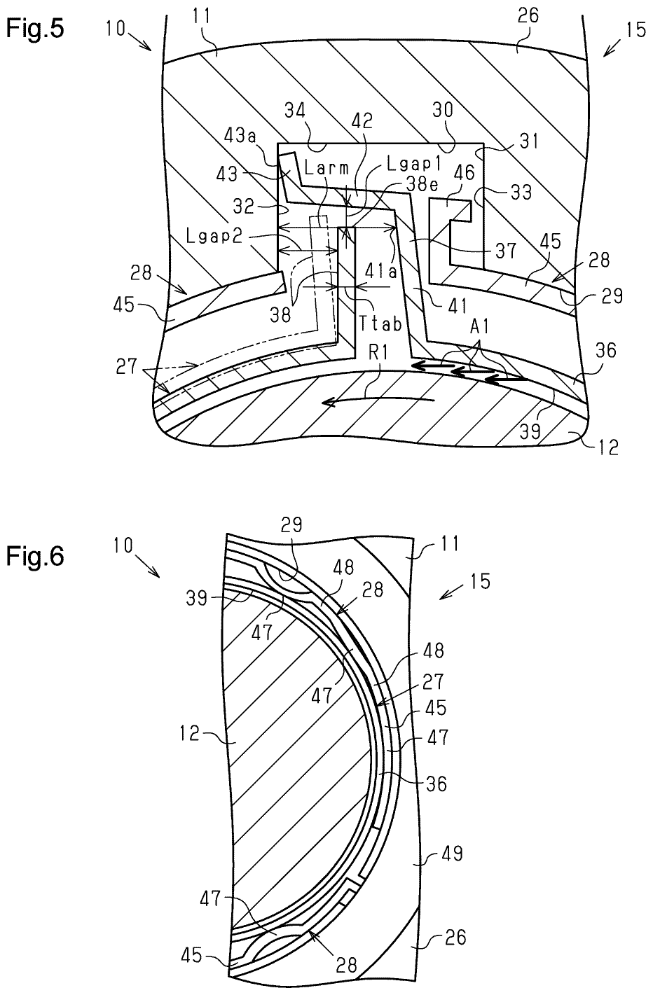

As shown in FIG. 5, the bearing retainer 26 includes a slot wall 31 defining the slot 30. The slot wall 31 includes a leading wall 32, a trailing wall 33, and a connection wall 34. The leading wall 32 is located at the leading side in the rotational direction R1 of the rotation shaft 12. The leading wall 32 extends from the inner circumferential surface of the bearing retainer 26 outward in the radial direction of the rotation shaft 12. The trailing wall 33 is located at the trailing side in the rotational direction R1 of the rotation shaft 12. The trailing wall 33 extends from the inner circumferential surface of the bearing retainer 26 outward in the radial direction of the rotation shaft 12. The leading wall 32 and the trailing wall 33 extend parallel to each other. The leading wall 32 and the trailing wall 33 are opposed to each other in the circumferential direction of the bearing retainer 26. The connection wall 34 connects an end of the leading wall 32 located outward in the radial direction of the rotation shaft 12 and an end of the trailing wall 33 located outward in the radial direction of the rotation shaft 12.

As shown in FIGS. 3 and 4, in addition to the slot 30, two sub-slots 35 are formed in the inner circumferential surface of the bearing retainer 26. The two sub-slots 35 extend in the axial direction of the bearing retainer 26. Each sub-slot 35 includes a first end opening in the first axial end surface of the bearing retainer 26. The sub-slot 35 includes a second end closed by a portion of the bearing retainer 26.

The slot 30 and the two sub-slots 35 are arranged at equal intervals in the circumferential direction of the bearing retainer 26. The slot 30 is greater than each of the sub-slots 35 in width in the circumferential direction of the bearing retainer 26. The circumferential direction of the bearing retainer 26 conforms to a circumferential direction of the rotation shaft 12.

### Top Foil

The top foil 27 is formed of a flexible metal material. The top foil 27 is formed of stainless steel or INCONEL (registered trademark). The top foil 27 has the form of a thin plate.

The top foil 27 includes a top foil body 36, a trailing edge tab 37, and a leading edge tab 38. The top foil body 36 is cylindrical. The top foil body 36 surrounds the outer circumferential surface of the rotation shaft 12. The top foil body 36 includes a bearing surface 39 supporting the rotation shaft 12. The bearing surface 39 is the inner circumferential surface of the top foil body 36. The bearing surface 39 is opposed to the outer circumferential surface of the rotation shaft 12.

As shown in FIG. 5, the top foil body 36 includes a first end located at the trailing side in the rotational direction R1 of the rotation shaft 12 and a second end located at the leading side in the rotational direction R1 of the rotation shaft 12. The first end and the second end of the top foil body 36 are opposed to and separated from each other in the circumferential direction of the top foil body 36. Thus, the top foil body 36 is partially cut away and non-annular.

### Trailing Edge Tab

The trailing edge tab 37 is formed by bending the first end of the top foil body 36 outward in the radial direction of the rotation shaft 12. The leading edge tab 38 is formed by bending the second end of the top foil body 36 outward in the radial direction of the rotation shaft 12. The trailing edge tab 37 and the leading edge tab 38 are inserted into the slot 30.

The trailing edge tab 37 includes a first extension 41 and a second extension 42. The first extension 41 extends from the top foil body 36 outward in the radial direction of the rotation shaft 12. The first extension 41 is bent from the first end of the top foil body 36 outward in the radial direction of the rotation shaft 12. The first extension 41 has the form of an elongated flat plate. The slot 30 receives an end of the first extension 41 located opposite from the top foil body 36.

The first extension 41 includes an opposing portion 41a opposed to a distal end 38e of the leading edge tab 38 in the circumferential direction of the rotation shaft 12. The second extension 42 extends, toward the leading wall 32, from the end of the first extension 41 located opposite from the top foil body 36. The second extension 42 has the form of an elongated flat plate. The second extension 42 extends in the slot 30 at an outer side of the leading edge tab 38 in the radial direction of the rotation shaft 12.

The trailing edge tab 37 includes a bent portion 43. The bent portion 43 is a distal portion of the trailing edge tab 37. The bent portion 43 is formed by bending the distal portion of the trailing edge tab 37. More specifically, the bent portion 43 is formed by bending the distal portion of the trailing edge tab 37 outward in the radial direction of the rotation shaft 12. The bent portion 43 has the form of an elongated flat plate. The bent portion 43 includes a side surface 43a in contact with the leading wall 32. The side surface 43a of the bent portion 43 is in contact with the leading wall 32 when the rotation shaft 12 is rotating. Also, the side surface 43a of the bent portion 43 is in contact with the leading wall 32 when the rotation shaft 12 is not rotating. Thus, the trailing edge tab 37 extends in the slot 30 at an outer side of the leading edge tab 38 in the radial direction of the rotation shaft 12, and the distal portion of the trailing edge tab 37 is in contact with the leading wall 32 at least when the rotation shaft 12 is rotating.

### Bump Foil

As shown in FIGS. 3 and 4, the radial bearing 15 includes three bump foils 28. Specifically, the radial bearing 15 includes the bump foils 28 separated in the circumferential direction. Each bump foil 28 has the form of a curved plate. The bump foil 28 is formed of a flexible metal material. The bump foil 28 is formed of stainless steel or INCONEL (registered trademark). The bump foil 28 has the form of a thin plate. The three bump foils 28 are disposed between the bearing retainer 26 and the top foil 27 at equal intervals in the circumferential direction of the rotation shaft 12. The three bump foils 28 are equal to each other in length in the circumferential direction of the rotation shaft 12.

Each bump foil 28 includes an elastic plate 45 and a fixing tab 46. The elastic plate 45 is disposed between the bearing retainer 26 and the top foil 27. More specifically, the elastic plate 45 is disposed between the inner circumferential surface of the bearing retainer 26 and the outer circumferential surface of the top foil body 36. The elastic plate 45 has the form of a curved plate. The curvature direction of the elastic plate 45 conforms to the circumferential direction of the rotation shaft 12.

The fixing tab 46 is formed by bending an end of the elastic plate 45 located in the circumferential direction of the rotation shaft 12 outward in the radial direction of the rotation shaft 12. The fixing tab 46 has the form of an elongated plate. The fixing tab 46 of one of the three bump foils 28 is inserted into the slot 30. The fixing tabs 46 of the remaining two of the three bump foils 28 are inserted into the sub-slots 35, respectively.

As shown in FIG. 5, the fixing tab 46 inserted in the slot 30 is disposed between the trailing edge tab 37 and the trailing wall 33 in the slot 30. The fixing tab 46 includes a distal portion separated from the trailing edge tab 37 in the circumferential direction of the rotation shaft 12 and bent close to the trailing wall 33. Thus, the fixing tab 46 extends from the elastic plate 45 toward the trailing wall 33. In other words, the fixing tab 46 includes a portion located, in the circumferential direction of the rotation shaft 12, closer to the trailing wall 33 than the end of the elastic plate 45 located in the circumferential direction of the rotation shaft 12. The cross section of the fixing tab 46 is hook-shaped.

As shown in FIG. 3, the elastic plate 45 includes ridges 47 and valleys 48. Thus, each bump foil 28 includes the ridges 47 and the valleys 48. Each ridge 47 is bulged and in contact with the top foil 27. The ridge 47 is in contact with the outer circumferential surface of the top foil body 36. The ridge 47 extends in the circumferential direction of the elastic plate 45. Each valley 48 is in contact with the inner circumferential surface of the bearing retainer 26. The elastic plate 45 is wave-shaped so that the ridges 47 and the valleys 48 are alternately arranged in the circumferential direction of the elastic plate 45. Each ridge 47 connects adjacent ones of the valleys 48 in the circumferential direction of the rotation shaft 12.

When the rotation shaft 12 rotates, air enters between the top foil 27 and the rotation shaft 12 and forms an air film between the top foil 27 and the rotation shaft 12. The rotation shaft 12 rotates in contact with the top foil 27 until the rotation speed of the rotation shaft 12 reaches the lift-off speed. When the rotation speed of the rotation shaft 12 reaches the lift-off speed, the dynamic pressure of the air film causes the rotation shaft 12 to lift off from the top foil 27. The top foil 27 radially supports the rotation shaft 12 via the air film. Thus, the top foil 27 supports the rotation shaft 12 in the radial direction.

The dynamic pressure of the air film between the top foil 27 and the rotation shaft 12 elastically deforms the top foil 27 and displaces the top foil 27 toward the elastic plate 45 of the bump foil 28. Thus, the top foil 27 forces the ridges 47 of the elastic plates 45 toward the bearing retainer 26. As a result, the elastic plates 45 elastically deform. The elastic plates 45 are displaced toward the bearing retainer 26 together with the top foil 27. The elastic plates 45 elastically support the top foil 27. Thus, the bump foils 28 elastically deform to elastically support the top foil 27 so that the top foil 27 is displaceable in the radial direction of the rotation shaft 12.

### Stopper

As shown in FIGS. 3 and 4, the radial bearing 15 includes a stopper 49. The stopper 49 is annular. The stopper 49 is formed of, for example, stainless steel. The hardness of the stopper 49 is less than the hardness of the top foil 27 and the hardness of the bump foil 28. The inner diameter of the stopper 49 is slightly larger than the diameter of the through hole 29. When the stopper 49 closes the first end of the slot 30 and the first end of each sub-slot 35, the stopper 49 is fixed to the first end surface of the bearing retainer 26. The stopper 49 is opposed to the trailing edge tab 37, the leading edge tab 38, and the fixing tabs 46 of the bump foils 28 in the axial direction of the bearing retainer 26.

When the trailing edge tab 37 and the leading edge tab 38 are in contact with the stopper 49, removal of the top foil 27 from the first end surface of the bearing retainer 26 is prevented. Also, when the fixing tabs 46 of the bump foils 28 are in contact with the stopper 49, removal of the bump foils 28 from the first end surface of the bearing retainer 26 is prevented.

### Leading Edge Tab

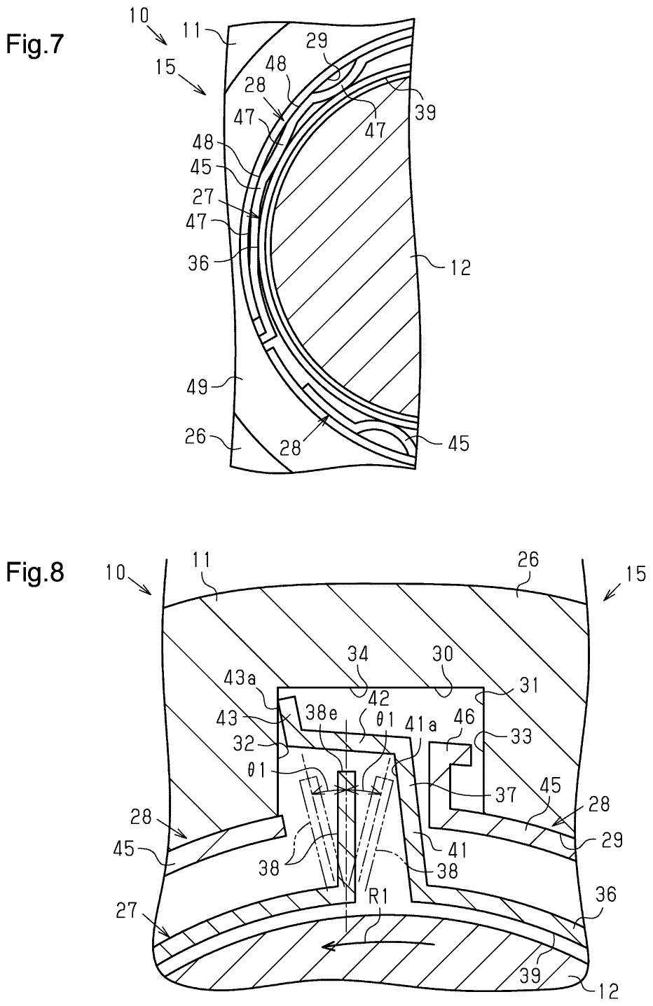

As shown in FIGS. 6 and 7, the rotation shaft 12 is movable in the radial direction of the rotation shaft 12. The rotation shaft 12 is movable until the top foil 27 completely compresses the ridge 47 of the elastic plates 45. The maximum displacement amount of the bump foil 28 is an amount of displacement from a state in which the ridge 47 is in the original shape to a state in which the ridge 47 is completely compressed. The maximum displacement amount of the bump foil 28 is less than the tip clearance amount between the impeller 13 and the shroud 24.

A stroke amount of the rotation shaft 12 movable from a state in which the axis L1 of the rotation shaft 12 coincides with the axis of the through hole 29 to a state in which the ridges 47 of the elastic plate 45 are completely compressed by the top foil 27 refers to the maximum stroke amount of the rotation shaft 12 in the radial direction of the rotation shaft 12 from a state in which the axis L1 of the rotation shaft 12 coincides with the axis of the through hole 29. Thus, the maximum stroke amount of the rotation shaft 12 in the radial direction of the rotation shaft 12 from a state in which the axis L1 of the rotation shaft 12 coincides with the axis of the through hole 29 is determined based on the smaller one of the tip clearance amount and the maximum displacement amount of the bump foil 28. In the description hereafter, “the maximum stroke amount of the rotation shaft 12 in the radial direction of the rotation shaft 12 from a state in which the axis L1 of the rotation shaft 12 coincides with the axis of the through hole 29” may simply be referred to as “the maximum stroke amount.”

As shown in FIG. 5, a distance Larm in the circumferential direction of the rotation shaft 12 between the opposing portion 41a and the leading wall 32 is set to be greater than a value obtained by adding double the maximum stroke amount and a thickness Ttab of the leading edge tab 38. A gap Lgap1 in the radial direction of the rotation shaft 12 between the distal end 38e of the leading edge tab 38 and the second extension 42 is greater than the maximum stroke amount. A distance Lgap2 in the circumferential direction of the rotation shaft 12 between the distal end 38e of the leading edge tab 38 and the leading wall 32 is greater than the maximum stroke amount.

As shown in FIG. 8, the angle of the leading edge tab 38 with respect to the top foil body 36 may vary within a tolerance during manufacturing of the top foil 27. In FIG. 8, a tolerance of an angle θ1 from the angle of the leading edge tab 38 with respect to the top foil body 36 is exaggeratedly shown by double-dashed lines. In addition, the overall length of the top foil 27 in the circumferential direction may vary within the tolerance during manufacturing of the top foil 27.

The distance Larm is set to be greater than a value obtained by adding double the maximum stroke amount, the thickness Ttab of the leading edge tab 38, the tolerance of the overall length of the top foil 27 in the circumferential direction, double the tolerance of the angle of the leading edge tab 38 with respect to the top foil body 36. Thus, the distance Larm in the circumferential direction of the rotation shaft 12 between the opposing portion 41a and the leading wall 32 is set further based on the tolerance of the overall length of the top foil 27 in the circumferential direction and the tolerance of the angle of the leading edge tab 38 with respect to the top foil body 36.

When the distance Larm, the gap Lgap1, and the distance Lgap2 are set as described above, the leading edge tab 38 is separated from the leading wall 32 and the trailing edge tab 37 when the rotation shaft 12 is rotating. In addition, the leading edge tab 38 is separated from the leading wall 32 and the trailing edge tab 37 when the rotation shaft 12 is not rotating. Thus, the leading edge tab 38 is separated from the leading wall 32 and the trailing edge tab 37 in the circumferential direction of the rotation shaft 12 at least when the rotation shaft 12 is rotating.

### Operation of Embodiment

The operation of the embodiment will now be described.

In the radial bearing 15 having the structure described above, when the rotation shaft 12 rotates, the trailing portion of the top foil body 36 located at the trailing side in the rotational direction R1, where the trailing edge tab 37 is located, may be drawn toward the rotation shaft 12 by the flow of air flowing between the top foil 27 and the rotation shaft 12. Specifically, the trailing portion of the top foil body 36 in the rotational direction R1 may be drawn toward the rotation shaft 12 as indicated by arrows A1 shown in FIG. 5.

In the present embodiment, at least when the rotation shaft 12 is rotating, the distal portion of the trailing edge tab 37 is in contact with the leading wall 32. Specifically, the side surface 43a of the bent portion 43 is in contact with the leading wall 32. This hinders the trailing portion of the top foil body 36 in the rotational direction R1 from being drawn toward the rotation shaft 12 by the flow of air flowing between the top foil 27 and the rotation shaft 12 when the rotation shaft 12 rotates. Thus, the catching of the trailing portion of the top foil body 36 in the rotational direction R1 on the rotation shaft 12 is avoided. The rotation shaft 12 is stably lifted off from the top foil 27 by the dynamic pressure of the air film generated between the top foil 27 and the rotation shaft 12.

Also, the leading edge tab 38 is separated from the leading wall 32 and the trailing edge tab 37 in the circumferential direction of the rotation shaft 12 at least when the rotation shaft 12 is rotating. This avoids interference with movement of the leading edge tab 38. Thus, the leading portion of the top foil body 36 located at the leading side in the rotational direction R1, where the leading edge tab 38 is located, is readily deformed so as to bend in a direction separating away from the rotation shaft 12 as indicated by double-dashed lines shown in FIG. 5. As a result, the gap between the leading portion of the top foil body 36 in the rotational direction R1 and the rotation shaft 12 is increased. Accordingly, air is readily drawn in from the gap between the leading portion of the top foil body 36 in the rotational direction R1 and the rotation shaft 12. Thus, the rotation shaft 12 is stably lifted off from the top foil 27 by the dynamic pressure of the air film generated between the top foil 27 and the rotation shaft 12.

### Advantages of Embodiment

The above described embodiment obtains the following advantages.
(1) At least when the rotation shaft 12 is rotating, the distal portion of the trailing edge tab 37 is in contact with the leading wall 32. This hinders the trailing portion of the top foil body 36 in the rotational direction R1 from being drawn toward the rotation shaft 12 by the flow of air flowing between the top foil 27 and the rotation shaft 12 when the rotation shaft 12 rotates. Thus, the catching of the trailing portion of the top foil body 36 in the rotational direction R1 on the rotation shaft 12 is avoided. The rotation shaft 12 is stably lifted off from the top foil 27 by the dynamic pressure of the air film generated between the top foil 27 and the rotation shaft 12.

Also, the leading edge tab 38 is separated from the leading wall 32 and the trailing edge tab 37 in the circumferential direction of the rotation shaft 12 at least when the rotation shaft 12 is rotating. This avoids interference with movement of the leading edge tab 38. Thus, the leading portion of the top foil body 36 in the rotational direction R1 is readily deformed so as to bend in a direction separating away from the rotation shaft 12. As a result, the gap between the leading portion of the top foil body 36 in the rotational direction R1 and the rotation shaft 12 is increased. Accordingly, air is readily drawn in from the gap between the leading portion of the top foil body 36 in the rotational direction R1 and the rotation shaft 12. Thus, the rotation shaft 12 is stably lifted off from the top foil 27 by the dynamic pressure of the air film generated between the top foil 27 and the rotation shaft 12. As described above, the radial bearings 15 stably support the rotation shaft 12 in the radial direction.
(2) The side surface 43a of the bent portion 43 is in contact with the leading wall 32. This advantageously increases the area of contact of the distal portion of the trailing edge tab 37 with the leading wall 32. Thus, the friction force between the distal portion of the trailing edge tab 37 and the leading wall 32 is decreased. This increases the durability.
(3) The fixing tab 46 is inserted in the slot 30 between the trailing edge tab 37 and the trailing wall 33 and extends from the elastic plate 45 toward the trailing wall 33. This facilitates contact of the fixing tab 46 with the trailing wall 33. When the fixing tab 46 is in contact with the trailing wall 33, the trailing edge tab 37 is readily positioned in the slot 30 between the fixing tab 46 and the leading wall 32 in the circumferential direction of the rotation shaft 12. As a result, at least when the rotation shaft 12 is rotating, the distal portion of the trailing edge tab 37 is in stable contact with the leading wall 32.
(4) The distance Larm in the circumferential direction of the rotation shaft 12 between the opposing portion 41a and the leading wall 32 is set to be greater than a value obtained by adding double the maximum stroke amount and the thickness Ttab of the leading edge tab 38. With this structure, at least when the rotation shaft 12 is rotating, contact of the leading edge tab 38 with the leading wall 32 and the trailing edge tab 37 is readily avoided. This avoids interference with movement of the leading edge tab 38.
(5) The distance Larm in the circumferential direction of the rotation shaft 12 between the opposing portion 41a and the leading wall 32 is set further based on the tolerance of the overall length of the top foil 27 in the circumferential direction and the tolerance of the angle of the leading edge tab 38 with respect to the top foil body 36. With this structure, at least when the rotation shaft 12 is rotating, contact of the leading edge tab 38 with the leading wall 32 and the trailing edge tab 37 is more readily avoided. This avoids interference with movement of the leading edge tab 38.
(6) The gap Lgap1 in the radial direction of the rotation shaft 12 between the distal end 38e of the leading edge tab 38 and the second extension 42 is greater than the maximum stroke amount. With this structure, at least when the rotation shaft 12 is rotating, contact of the leading edge tab 38 with the second extension 42 of the trailing edge tab 37 is avoided. This further avoids interference with movement of the leading edge tab 38.
(7) The distance Lgap2 in the circumferential direction of the rotation shaft 12 between the distal end 38e of the leading edge tab 38 and the leading wall 32 is greater than the maximum stroke amount. With this structure, at least when the rotation shaft 12 is rotating, contact of the leading edge tab 38 with the leading wall 32 is more readily avoided. This further avoids interference with movement of the leading edge tab 38.

### Modified Examples

The above embodiment may be modified as described below. The embodiment and the following modified examples may be combined as long as the combined modified examples remain technically consistent with each other.

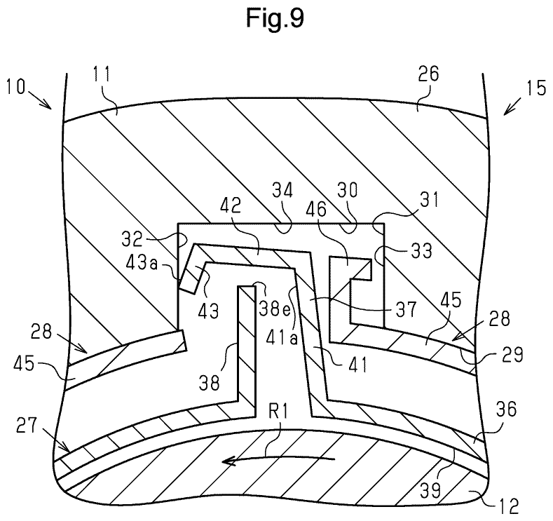

As shown in FIG. 9, the bent portion 43 may be formed by bending the distal portion of the trailing edge tab 37 inward in the radial direction of the rotation shaft 12. This structure allows the depth of the slot 30 from the inner circumferential surface of the bearing retainer 26 to be lessened as compared to, for example, a structure in which the distal portion of the trailing edge tab 37 is bent outward in the radial direction of the rotation shaft 12. As a result, the radial bearings 15 may be reduced in size in the radial direction of the rotation shaft 12.

In the embodiment, the side surface 43a of the bent portion 43 may be separated from the leading wall 32 when the rotation shaft 12 is not rotating. That is, the trailing edge tab 37 may be configured so that the distal portion of the trailing edge tab 37 is in contact with the leading wall 32 at least when the rotation shaft 12 is rotating.

In the embodiment, when the rotation shaft 12 is not rotating, the leading edge tab 38 may be in contact with the leading wall 32 and the trailing edge tab 37. That is, the leading edge tab 38 may be configured to be separated from the leading wall 32 and the trailing edge tab 37 in the circumferential direction of the rotation shaft 12 at least when the rotation shaft 12 is rotating.

In the embodiment, the bent portion 43 has the form of an elongated flat plate. Alternatively, for example, the bent portion 43 may have the form of a curved plate.

In the embodiment, the trailing edge tab 37 does not have to include the bent portion 43. In an example, the distal end of the second extension 42 may be in contact with the leading wall 32. In this case, the distal portion of the second extension 42 defines the distal portion of the trailing edge tab 37. That is, the distal portion of the trailing edge tab 37 may be in contact with the leading wall 32.

In the embodiment, the fixing tab 46 may be gradually inclined toward the trailing wall 33 as the distance from the elastic plate 45 increases. That is, the fixing tab 46 may extend from the elastic plate 45 toward the trailing wall 33.

In the embodiment, the tip clearance amount between the impeller 13 and the shroud 24 may be smaller than the maximum displacement amount of the bump foil 28. In this case, the tip clearance amount between the impeller 13 and the shroud 24 is the maximum stroke amount of the rotation shaft 12 in the radial direction of the rotation shaft 12 from a state in which the axis L1 of the rotation shaft 12 coincides with the axis of the through hole 29. As described above, the maximum stroke amount is determined based on the smaller one of the tip clearance amount and the maximum displacement amount of the bump foil 28.

In the embodiment, the distance Larm in the circumferential direction of the rotation shaft 12 between the opposing portion 41a and the leading wall 32 may be set without considering the tolerance of the overall length of the top foil 27 in the circumferential direction and the tolerance of the angle of the leading edge tab 38 with respect to the top foil body 36.

In the embodiment, the gap Lgap1 in the radial direction of the rotation shaft 12 between the distal end 38e of the leading edge tab 38 and the second extension 42 may be less than or equal to the maximum stroke amount.

In the embodiment, the distance Lgap2 in the circumferential direction of the rotation shaft 12 between the distal end 38e of the leading edge tab 38 and the leading wall 32 may be less than or equal to the maximum stroke amount.

In the embodiment, the bump foils 28 do not have to be separated in the circumferential direction. In this case, the two sub-slots 35 may be omitted from the inner circumferential surface of the bearing retainer 26.

In the embodiment, a groove may be formed in the inner circumferential surface of the bearing retainer 26, and a foil member may extend along the inner surface of the groove. The foil member may include the slot wall 31 defining the slot 30.

In the embodiment, the radial bearings 15 may further include a bearing housing as a component differing from the housing 11. In this case, for example, the opposite ends of the slot 30 may have openings in opposite end surfaces of the bearing housing. Then, the stopper 49 may be fixed to the opposite end surfaces of the bearing housing to prevent removal of the top foil 27 and the bump foil 28 from the opposite end surfaces of the bearing housing.

In the embodiment, the centrifugal compressor 10 does not have to be mounted on a fuel cell electric vehicle. That is, the centrifugal compressor 10 is not limited to a compressor mounted on a vehicle.

In the embodiment, the centrifugal compressor 10 is not limited to one used to compress air supplied to a fuel cell electric vehicle. That is, the centrifugal compressor 10 may be configured to compress a fluid.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A foil bearing supporting a rotation shaft in a radial direction, comprising:
a bearing housing having a through hole through which the rotation shaft is inserted;
a top foil disposed between the rotation shaft and the bearing housing and having a form of a thin plate;
a bump foil disposed between the bearing housing and the top foil and elastically supporting the top foil, the bump foil having a form of a thin plate; and
a slot formed in an inner circumferential surface of the bearing housing and extending in an axial direction of the bearing housing, wherein
the top foil includes
a tubular top foil body including a bearing surface that supports the rotation shaft and surrounding an outer circumferential surface of the rotation shaft,
a trailing edge tab formed of an end of the top foil body located at a trailing side in a rotational direction of the rotation shaft being bent outward in a radial direction of the rotation shaft, and
a leading edge tab formed of an end of the top foil body located at a leading side in the rotational direction being bent outward in the radial direction,
the trailing edge tab and the leading edge tab are inserted into the slot,
the slot is defined by a slot wall including a leading wall located at the leading side in the rotational direction,
the trailing edge tab extends in the slot at an outer side of the leading edge tab in the radial direction,
the trailing edge tab includes a distal portion configured to contact the leading wall at least when the rotation shaft is rotating, and
the leading edge tab is separated from the leading wall and the trailing edge tab in a circumferential direction of the rotation shaft at least when the rotation shaft is rotating.

2. The foil bearing according to claim 1, wherein
the trailing edge tab includes a bent portion formed by bending the distal portion of the trailing edge tab, and
the bent portion includes a side surface in contact with the leading wall.

3. The foil bearing according to claim 2, wherein the bent portion is formed by bending the distal portion of the trailing edge tab inward in the radial direction.

4. The foil bearing according to claim 1, wherein
the bump foil includes
an elastic plate located between the bearing housing and the top foil, and
a fixing tab formed of an end of the elastic plate located at one side in the circumferential direction being bent outward in the radial direction,
the slot wall further includes a trailing wall located at the trailing side in the rotational direction, and
the fixing tab is inserted in the slot between the trailing edge tab and the trailing wall and extends from the elastic plate toward the trailing wall.

5. The foil bearing according to claim 1, wherein
an impeller is coupled to the rotation shaft,
the impeller is configured to be accommodated in an impeller chamber defined by a shroud,
the trailing edge tab includes
a first extension extending from the top foil body outward in the radial direction, and
a second extension extending from an end of the first extension opposite from the top foil body toward the leading wall, the second extension extending in the slot at an outer side of the leading edge tab in the radial direction,
the first extension includes an opposing portion opposed to a distal end of the leading edge tab in the circumferential direction,
a maximum stroke amount of the rotation shaft in the radial direction from a state in which an axis of the rotation shaft coincides with an axis of the through hole is determined based on a smaller one of a tip clearance amount between the impeller and the shroud and a maximum displacement amount of the bump foil,
a distance in the circumferential direction between the opposing portion and the leading wall is set to be greater than a value obtained by adding double the maximum stroke amount and a thickness of the leading edge tab.

6. The foil bearing according to claim 5, wherein
the distance in the circumferential direction between the opposing portion and the leading wall is set further based on a tolerance of an overall length of the top foil in the circumferential direction and a tolerance of an angle of the leading edge tab with respect to the top foil body.

7. The foil bearing according to claim 1, wherein
an impeller is coupled to the rotation shaft,
the impeller is configured to be accommodated in an impeller chamber defined by a shroud,
the trailing edge tab includes
a first extension extending from the top foil body outward in the radial direction, and
a second extension extending from an end of the first extension opposite from the top foil body toward the leading wall, the second extension extending in the slot at an outer side of the leading edge tab in the radial direction,
a maximum stroke amount of the rotation shaft in the radial direction from a state in which an axis of the rotation shaft coincides with an axis of the through hole is determined based on a smaller one of a tip clearance amount between the impeller and the shroud and a maximum displacement amount of the bump foil, and
a gap in the radial direction between the distal end of the leading edge tab and the second extension is greater than the maximum stroke amount.

8. The foil bearing according to claim 1, wherein
an impeller is coupled to the rotation shaft,
the impeller is configured to be accommodated in an impeller chamber defined by a shroud,
the trailing edge tab includes
a first extension extending from the top foil body outward in the radial direction,
a second extension extending from an end of the first extension opposite from the top foil body toward the leading wall, the second extension extending in the slot at an outer side of the leading edge tab in the radial direction,
a maximum stroke amount of the rotation shaft in the radial direction from a state in which an axis of the rotation shaft coincides with an axis of the through hole is determined based on a smaller one of a tip clearance amount between the impeller and the shroud and a maximum displacement amount of the bump foil, and
a distance between a distal end of the leading edge tab and the leading wall in the circumferential direction is greater than the maximum stroke amount.
